(19) United States
(12) Patent Application Publication
(10) Pub. No.: US 2004/0209613 A1
(43) Pub. Date: Oct. 21, 2004

(54) Network management

(76) Inventors: Mark Alexander Hunter, Menai (AU); Scott William Nelson, Dallas, TX (US)

Correspondence Address: SUGHRUE MION, PLLC, 2100 PENNSYLVANIA AVENUE, N.W., SUITE 800, WASHINGTON, DC, 20037, US

(21) Appl. No.: 10/399,479

(22) PCT Filed: Apr. 18, 2003
(86) PCT No.: PCT/EP01/09736

(51) Int. Cl. H04Q 7/20

(52) U.S. Cl. 455/426.1; 455/414.1; 455/436

(57) ABSTRACT

The invention teaches a new method of managing a network and a new kind of network management arrangement. The network management arrangement contains a logical entity which model one or several virtual managed network. These virtual managed networks augment the network layer with end-to-end service details, beyond the raw connectivity information.

This invention relates to the management of communication networks.

To support the ever-increasing complexity of networks and services being managed by the telecommunications network operator, there is a need for a comprehensive management model that can be used to represent and encapsulate the evolving network.

This invention relates to a new kind of network management concept which is in the following specified as Virtual Managed Network.

The Virtual Managed Network has been designed to support the building of network infrastructure for shored services, the partitioning of scarce resources as well as the allocation and management of individual “users” of the network—and provides mechanisms for:

Grouping one (or more) VPN's (Virtual Private Network) with associated network resources (e.g. servers and gateways).

Containing the relationship definitions (or associations) between users, gateways, servers and the VPN's.

At the heart of the VMN (Virtual Managed Network) is the Virtual Managed Network object—which is a logical entity—designed to augment the network layer with the end-to-end service details, beyond the raw connectivity information. It forms a framework of “services” to be created within the managed network, in a coherent and flexible manner, across many network types (i.e. mobile, PSTN, data, IP, etc.).

This logical entity enables the network operator to manage the network via the virtual managed network. The operator may further access views of the virtual managed network and manipulating the virtual managed network.

So, the virtual managed network concept provides a way to model a managed network within a network management arrangement in a user friendly way. Further, it provides an effective way to adopted the network management system to a complex and dynamically changing network environment with multiple network operators.

In the following, the concepts and functions of the VMN and, more specifically, the behavior of the VMN and its contained functions is described.

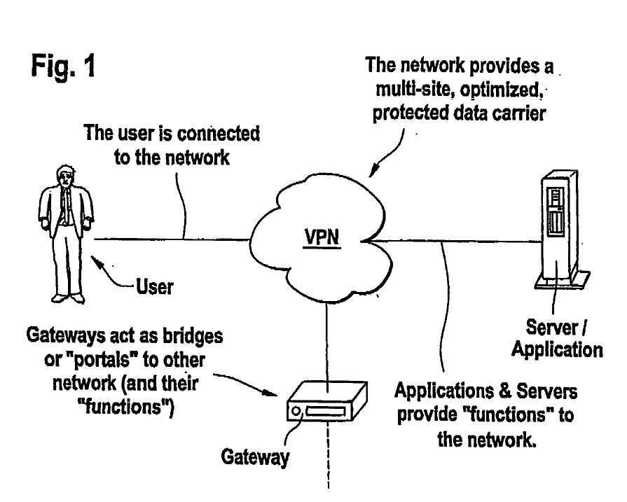

FIG. 1 shows an overview of the relations between components of a VMN.

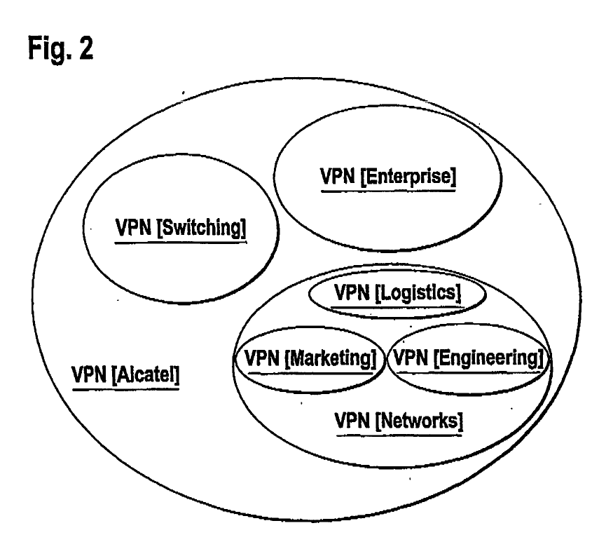

FIG. 2 shows a possible containment between virtual privat networks modeled within a VMN.

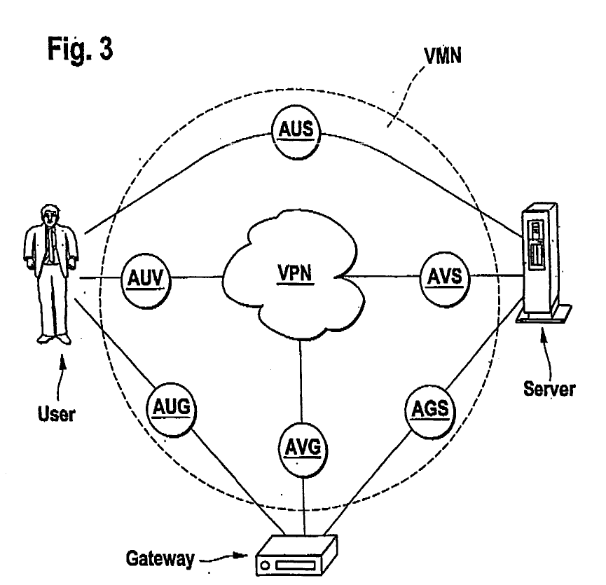

FIG. 3 shows associations within a VMN.

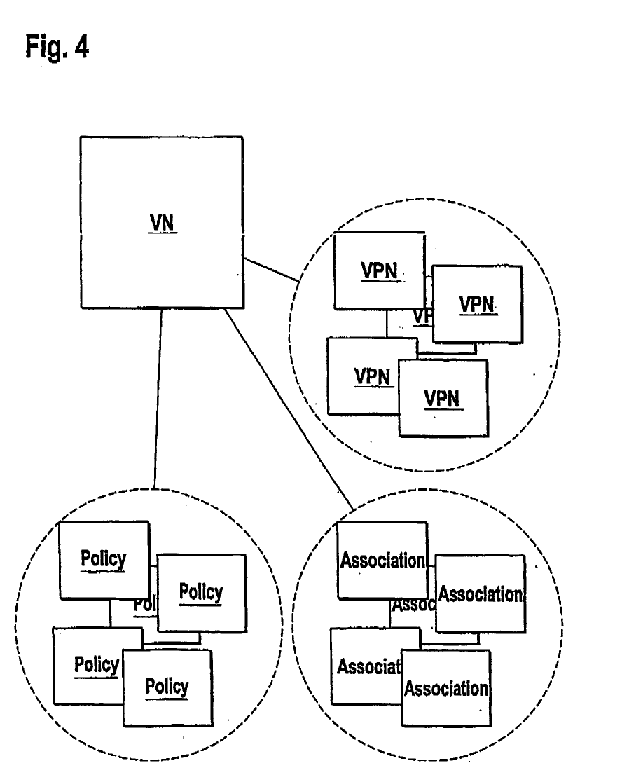

FIG. 4 shows a VMN object.

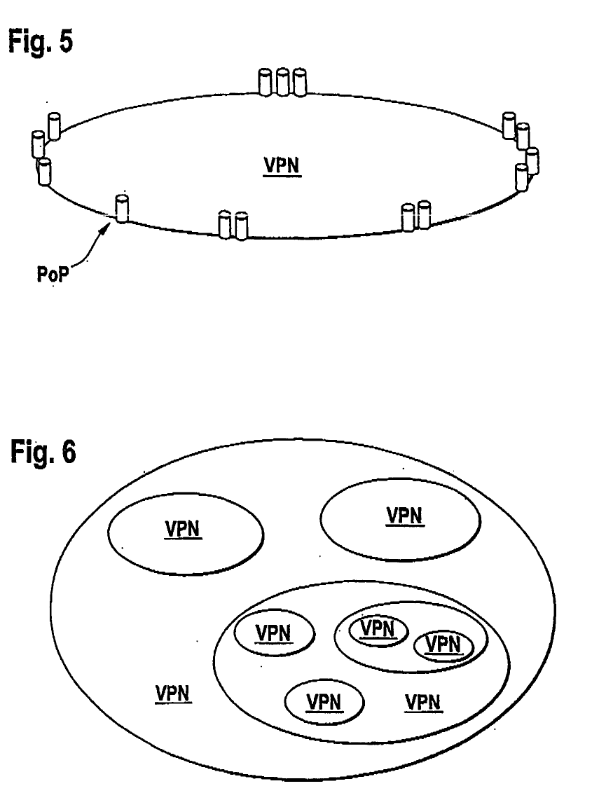

FIG. 5 shows a virtual private network.

FIG. 6 shows a possible containment between virtual privat networks modeled within a VMN.

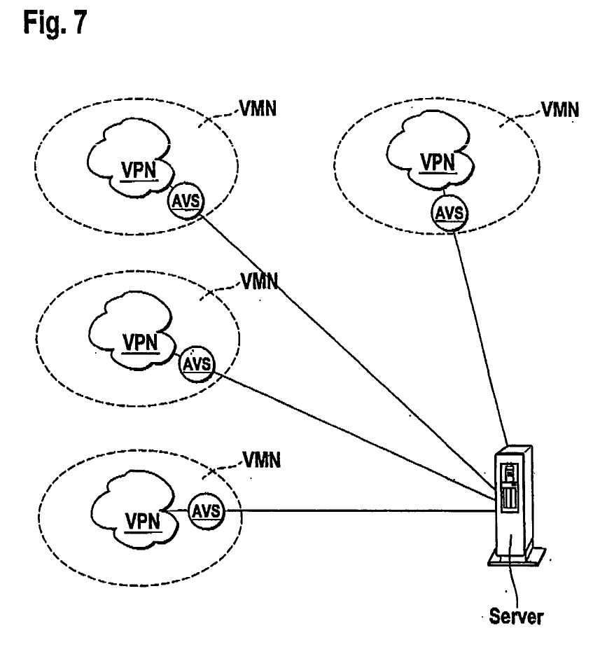

FIG. 7 shows a server.

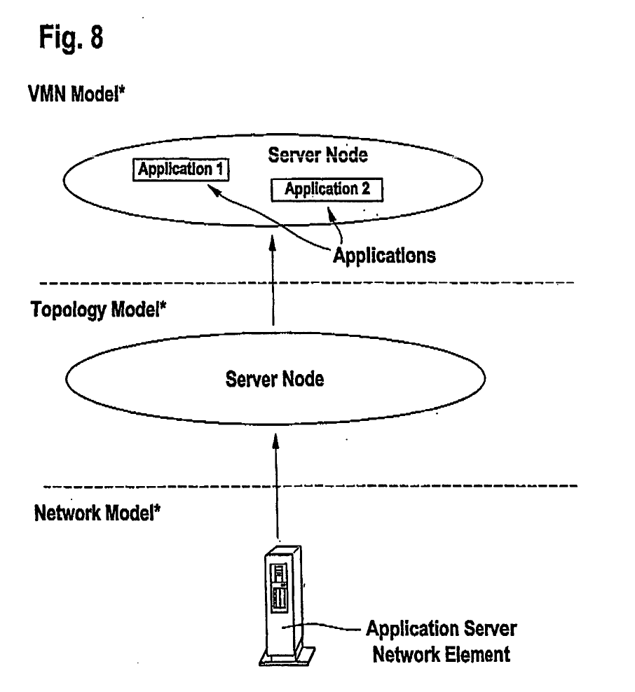

FIG. 8 demonstrate the specification of a server according to a network model. A topology model and a VMN model

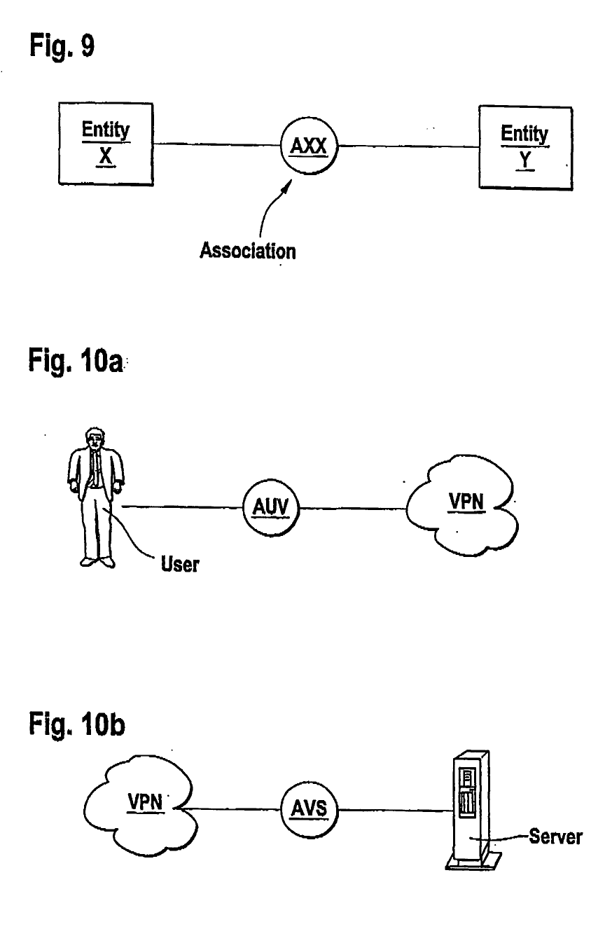

FIG. 9 shows an association.

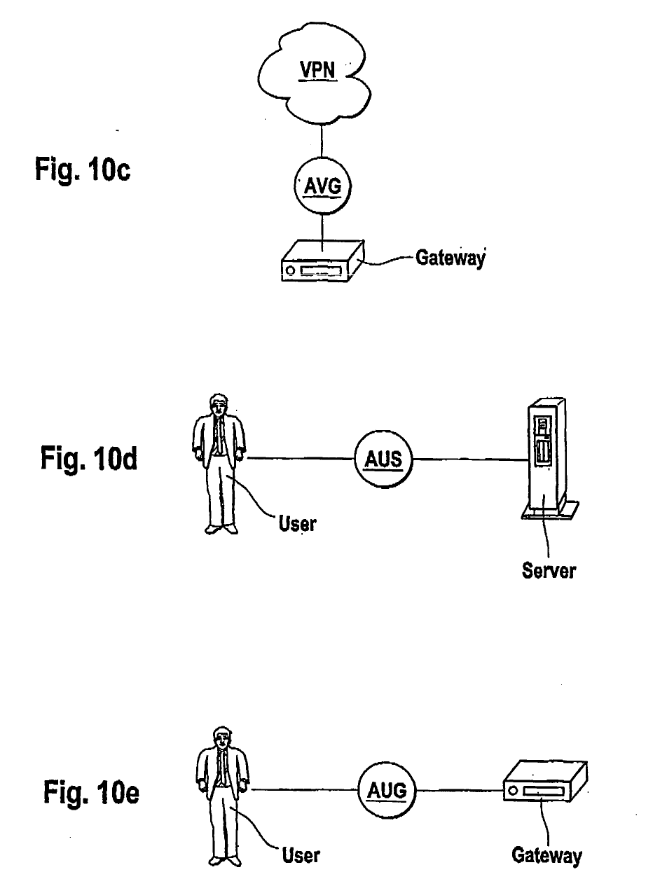

FIG. 10a to FIG. 10e shows different kinds of associations.

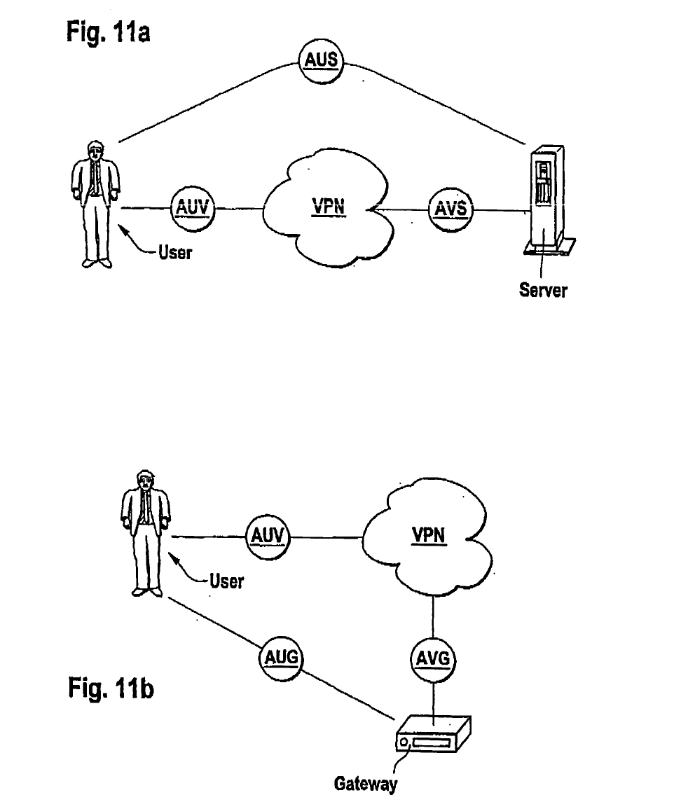

FIG. 11a and FIG. 11b demonstrate the relation between different kind of associations.

FIG. 1 shows the functions and facilities being supplied to the customers of Telecommunications Operators and the relation between the components User, Server, Application, VPN and Gateway.

Considering FIG. 1, let us consider that the network to be managed includes the following:

The network-connectivity, defined as a VPN, which the customer uses to link one (or more) sites (and Users) to each-other and the servers which provide the associated applications.

The actual applications themselves—as well as the servers that provide (or export) these applications.

The Users, which connect through some VPN to one or more Servers and Gateways.

The Gateways which allow traffic-exchange between two (or more) managed networks.

Each component is considered in more detail below:

The component User, is an entity that draws functions (or services) from the managed network—be it an individual, a corporation or other entity. User's are usually personified (or realized) through some device (i.e. computer, mobile phone, telephone, etc.).

The components VPN provides a connectivity framework between the Servers, Users and Gateways. Typically, the term (and concepts) associated with VPN are used to represent an IP based, multi-site connectivity framework. However, let us consider some other networks that can be called VPN's, such as:

A mobile (i.e. GSM, CDMA, etc.) network. These networks, whilst having a large number of users connected to them, never-the-less fit the bill as a controlled, connectivity framework—capable of delivering services (from servers) to the users.

The PSTN network. Again, there is no reason not to consider the PSTN network as one large VPN, delivering services to the users.

X.25 Closed User Groups (or indeed the entire X.25 network). It is obvious that the CUG functionality delivered by X.25 networks is indeed a VPN service—satisfying our criteria for inclusion as one.

There are many more examples of a VPN, each satisfying the requirement to be a secure, managed environment for services to be exploited by users. Additionally, VPNs may contain other VPNs. For instance—as illustrated by FIG. 2—the Alcatel-VPN may contain the divisional VPNs—Switching-VPN, NetworkApplications-VPN and Enterprise-VPN, with each of these divisions containing departmental VPNs, such as Marketing-VPN, Engineering-VPN and Logistics-VPN.

The components Server provides one or more services to the users attached to the VPN.

Typically, the concept of a server is usually associated with some UNIX or Windows™ host supplying some (data network) function, such as DHCP, DNS or Email hosting. However, the concept can (and should) extend to any generic function/equipment that provide services to users through the network.

Examples of such servers include VoiceMail systems (on Mobile or PSTN networks), IN (=Intelligent Network) servers (again with the PSTN) or even VoD (=Video on demand) servers.

The components Gateway provide within the network a managed point of connectivity between two VPN's. Once again, the term conjures up images of IP Firewalls or IP Routers. However, the term (and concept) extends to other gateways such as SS7 Signalling Gateways, International (Transit) Switches, (even) PABX links, Web-Portals and Secure-Framework Inhibitors.

FIG. 3 highlights the fad that an VMN contains a new entity, not directly seen as a service or network infrastructure. This entity, called on “association”, defines the relationships between the different components within the managed network and, indeed, provides the operator with the facilities to manage all aspects of the customer's service. FIG. 3 shows the Associations AUS, AUV, AVS, AUG, AVG, AGS which respectively defining the relationship indicated by FIG. 3.

The VMN architecture provides a framework for managing complex network services. It includes the VMN object, which is a “container object”, that collects together the VPN, Server, Gateway and Association objects defined for the specific managed network. The VMN then provides the necessary functions (methods) required by the network operator to effective add, modify, monitor, bill and delete a managed service.

In the following, the functions provided by these objects, the interworking between these objects, and components modeled by these objects are described in detail.

As shown by FIG. 4, the object VMN itself is created as an “infrastructure” function, with each of the objects representing servers, gateways and VPNs being added to the object VMN through a separate function. A key point to note is that, although Users, Gateways and Servers are manipulated (managed) within the VMN framework, they are not maintained within the VMN “container”.

The VPN provides an optimised connectivity framework for all users and services within the VMN. More precisely, we define a VPN as following:

A VPN is a communications environment where capabilities are controlled to permit peer connections and services only within a defined community of interest, and is constructed through some form of partitioning of a common underlying communications medium, where this underlying communications medium provides services to the network on a non-exclusive basis.

A VPN represented by an VPN object can, thus, be defined as either a “connectivity scheme” or a “segmentation policy”. Additionally, there exists an associated set of access-points into that “connectivity scheme”/“segmentation policy”. These access-points are referred to as Points-of-Presence (or PoPs), and represent a place within the managed network where a user, application/server or gateway may access the framework that is the VPN. FIG. 5 shows such a simple VPN description with several PoPs.

Any VPN (object) con contain other VPN's (objects), however, no VPN may belong (or be contained within) more than one other VPN. Similarly, a VPN may not overlap with another VPN—other than in a pure containment strategy—as depicted by FIG. 6.

A VPN is defined as a set of Policies and Points of Presence. The Policies identify (or define) the VPN's capabilities in supporting specific functions—and what conditions must be placed on any entity wishing to utilize those capabilities. The set of Points Of Presence (PoP), define the points (“physical” or “logical”) where any individual (user), system (application) or process must connect to in-order to access the VPN.

The parent (or containing) VPN object contains references to its immediately contained VPN objects. The supported set of Policies for any given VPN is defined as the intersection of all the policies of the immediately contained VPN's—in union with any policies specifically assigned to that VPN. However, the set of PoP's associated with the parent (or macro) VPN object is defined to be the union of all the PoP's from the immediately contained VPN's.

A Server represented by a server object is a network infrastructure component—like a router, switch or transmission multiplexer—that provides a set of applications (or services) to the network. A server does not necessarily “belong” to any one VMN (similar in nature to the way no switch typically belongs to one path) although a server may be tagged as being owned, or specified for exclusive use by, a single VMN.

Typically, one Server “host” may support multiple VPN's—all partitioned according to the associations (and their associated policies) relating the server to the VPN—as depicted within FIG. 7. From FIG. 7, it should be noted that each of the Associations (AVS) within each VMN, may define a different partition (function group or range) of the servers functional area, including overlapping areas between each of the specifications.

As detailed above, the Server itself does not belong to the VMN. However, a server may be tagged for exclusive use by a selected VMN or by a selected Customer. Alternatively, a Server may be tagged as a non-exclusive-preferred resource, in which case any functions for the specified VMN will attempt to utilize the specific Server—but the Server is not marked for exclusive use by that VMN.

According to a preferable embodiment, a server is modeled as a ServerNode object (a specialization of a network object) whilst the applications are modeled as, application objects—with a well defined containment strategy defining the relationship between the server and the application—as depicted by FIG. 8.

Usability wise, a server and thereby a server object may be created (i.e. added to the network infrastructure) as part of a VMN operation (i.e. the .addServer( . . . ) function), with a parameter specifying whether or not it should be tagged as exclusive or non-exclusive-preferred.

If, however, one (or more) of the policies defined within an association between a VPN and a server can only be implemented through exclusive use of a server, then—by definition—that requirement will over-ride any “exclusivity” attribute on the server itself.

Gateways represented by gateway objects act as “communication (or application) portals” between VPN's and, thus, VMN's. A gateway may be realized within the network as a router, switch, Unix/Windows™ host or even a physical connection (i.e. bit-pipe). Within the VMN framework, the gateway provides the mechanisms to specify and/or identify the inter-VPN communication/exchange-of-information functions.

Gateways are, by definition, bi-directional in that not only to they specify/identify the functions/information available to the VMN, they specify what external systems may be able to access from the VMN.

Like servers, gateways may be shared amongst multiple VMN's, depending on the functions they are fulfilling. However, again like the server function, if one (or more) of the policies defined within an association between a VPN and a gateway can only be implemented through exclusive use of a gateway, then this requirement will over-ride any “exclusivity” attribute specified for that gateway.

Associations provide the “glue” to bind the user to the managed network and the functions (applications) provided by the gateways and servers. Associations contain, at least, one set of policies which define the way two (or more) entities relate to each other—as depicted by FIG. 9.

There are specifically defined associations within a VMN, which can be created, updated and deleted through the VMN framework. An association can only be created between two existing (in terms of the management system) entities, such that if an association is to be built between a VPN and a server, then both have to be defined within the management domain.

The User-To-VPN association AUV, depict by FIG. 10a, defines the way in which on individual user can access the VPN and what functions (applications) are available to them from that VPN. If no policy set is defined within an association, then the default policy set, defined for the VPN is used to define the relationship.

The VPN-to-Server association AVS, depict by FIG. 10b, defines the applications (functions) exported by the servers to the the VPN, as well as the “filters” that may be applied by the VPN to those applications.

Where the policy-set defined for the association AVS is greater than the default policy-set defined for the VPN, the default policy-set is expanded by the addition or, in set theory terms, the union of the new policies defined within the association—such that:

PolicySet[VPN_{Default}]=PolicySet(VPN_{Default}]∪PolicySet[AVS]

It is important to note, here, that a policy-set may be introducing “restrictions” rather than new applications or information—so a cumulative operation, such as the union function may actually result in less applications or information being made available on the VPN—pending the types of policies being defined.

The VPN-to-Gateway association AVG, depict by FIG. 10c, defines the applications (functions) accessible, by default, from the external network(s) from within the VPN via that Gateway. Also, it specifies what applications and information are available to the external network(s) from the VPN via the gateway (i.e. the gateway is bi-directional—thus the policies specified for the gateway must encapsulate this).

The User-To-Server association AUS, depict by FIG. 10d, directly defines the applications and information accessible by a user from a particular server.

It should be noted that the actual applications and information available to the user may not actually be equivalent to those defined within AUS as depict by FIG. 11. Primarily, as stated previously, there exists two other Associations which impact on this relationship, namely AUV (i.e. the association between the user and the VPN) and AVS (i.e. the association between the VPN and the Server).

In effect, the actual set of applications and information is defined as:

PolicySet[Actual]=(PolicySet[AUS]∩(PolicySet[AUS]∩PolicySet[AVS]))

such that it is the intersection (of the supported policies) between each of the policy-sets defined for each association.

The User-To-Gateway association AUG, depict by FIG. 10d, directly defines the applications and information accessible by a user from external networks via the specific gateway.

Like the user-to-server association AUS, the actual applications and information available to the user may not actually be equivalent to those defined within AUG, as depict by FIG. 11b. In this case, the previously defined Associations AUV (i.e. the association between the user and the VPN) and AVG (i.e. the association between the VPN and the gateway) will act as filtering mechanisms.

In this case, the actual set of applications and information is defined as:

PolicySet[Actual]=(PolicySet[AUG]∩(PolicySet[AUV]∩PolicySet[AVG]))

such that it is the intersection (of the supported policies) between each of the policy-sets defined for each association.

The Gateway-to-Server association AGS directly defines the applications and information accessible by the gateway from the specified servers.

Its behavior (and policy-set) is similar to that defined for the User-to-Server functionality,

1. A method of managing a network containing the steps of providing within the network management arrangement a logical entity which model one or several virtual managed network, the virtual managed networks augment the network layer with end-to-end service details, beyond the raw connectivity information;
enabling the network operator to manage the network via the virtual managed network provided by the logical entity.

2. Method according to claim 1 wherein the logical entity provides a framework of services for creating a virtual managed network within the managed network across many network types, e.g. mobile, PSTN, data, IP networks.

3. Method according to claim 1 wherein the logical entity groups one or more virtual private networks with associated network resources in order to model the virtual managed network.

4. Method according to claim 1 wherein the logical entity stores relationship definitions between users, gateways, servers and the virtual private networks.

5. A network management arrangement for managing a network, containing
a virtual managed network object representing a virtual managed network,
one or several virtual private network objects respectively representing a virtual private network component of the managed network,
one or several server objects respectively representing a server component of the managed network,
one or several gateway objects respectively representing a gateway component of the managed network, and
one or several association objects defining one or several relationships between different components of the managed network.

6. A network management arrangement according to claim 5, wherein the virtual managed network object is a container object, that collects together virtual private network objects, server objects, gateway objects and association objects.

7. A network management arrangement according to claim 5, wherein the virtual managed network object is created as an infrastructure function, with each of the objects representing components of the managed network being added to the object through a separate function.

8. A network management arrangement according to claim 5, wherein the virtual managed network object provide functions enabling the network operator to add, modify, monitor, bill and delete managed services within the virtual managed network.

9. A network management arrangement according to claim 5, wherein a virtual private network is specified by the virtual private network object as either a connectivity scheme or a segmentation policy.

10. A network management arrangement according to claim 9, wherein the virtual private network object additionally contains an associated set of access-points into the connectivity scheme or segmentation policy.

11. A network management arrangement according to claim 5, wherein a virtual private network is specified by the virtual private network object as a set of policies and points of presence.

12. A network management arrangement according to one of the claims 5, 9, 10 or 11, wherein the virtual private network object contains one or several other virtual private network object.

13. A network management arrangement according to claim 5, wherein a virtual private network object represents a mobile network or a PSN network.

14. A network management arrangement according to claim 5, wherein a server object specifies a network infrastructure component—like a router, switch or transmission multiplexer—that provides a set of applications to the network.

15. A network management arrangement according to claim 14, wherein the applications are modeled as application objects and a well defined containment strategy defining the relationship between the server and the application objects.

16. A network management arrangement according to claim 5, wherein a gateway object specifies communication or application portals between virtual private networks.

17. A network management arrangement according to claim 5, wherein a association object contains a set of policies which define the way two or more components relate to each other.
